(19) United States
(12) Patent Application Publication
(10) Pub. No.: US 2025/0298123 A1
(43) Pub. Date: Sep. 25, 2025

(54) METHOD AND SYSTEM FOR PERCEIVING PHYSICAL BODIES, WITH OPTIMIZED SCANNING

(71) Applicant: COMMISSARIAT A L’ENERGIE ATOMIQUE ET AUX ENERGIES ALTERNATIVES, PARIS (FR)

(72) Inventors: Aurélien FRESNEAU, GRENOBLE Cedex 09 (FR); Diego PUSCHINI PASCUAL, GRENOBLE Cedex 09 (FR)

(21) Appl. No.: 18/863,288

(22) PCT Filed: May 15, 2023
(86) PCT No.: PCT/EP2023/062963

§ 371 Date: Nov. 5, 2024

(30) Foreign Application Priority Data
May 17, 2022 (FR) 2204651

(51) Int. Cl. G01S 7/41; G01S 7/48; G01S 7/539

(52) U.S. Cl. CPC G01S 7/411; G01S 7/415; G01S 7/4802; G01S 7/539

(57) ABSTRACT

A method for perceiving physical bodies in an environment, including the following steps: a) controlling a sensor in an acquisition sequence, with the sensor having a detection region that can be oriented in order to acquire a plurality of distance measurements of the physical bodies; b) determining, based on each of the distance measurements, a probability of occupancy of a set of cells of an occupancy grid by a physical body; and c) constructing a consolidated occupancy grid by Bayesian fusion of the probabilities of occupancy estimated during step b); wherein the detection region of the sensor has a variable angular width and in that the method also comprises the following steps: d) identifying, based on the occupancy grid, at least one region of interest of the environment; and e) determining, based on the one or more regions of interest identified during step d), one of the acquisition sequences defining, for each distance measurement, at least the orientation and the angular width of the detection region of the sensor. A system for implementing such a method is also provided.

### CROSS-REFERENCE TO RELATED APPLICATIONS

This application is a National Stage of International patent application PCT/EP2023/062963, filed on May 15, 2023, which claims priority to foreign French patent application No. FR 2204651, filed on May 17, 2022, the disclosures of which are incorporated by reference in their entireties.

### FIELD OF THE INVENTION

The invention relates to a method and a system for perceiving and estimating the position, and optionally the speed, of physical bodies in an environment, using one or more distance sensors such as radar, Lidar or sonar, for example.

### BACKGROUND

“Physical body” is understood to mean any physical substance or object that is unique and is able to be detected and identified by an appropriate sensor. Thus, physical bodies are considered to be inanimate objects, whether they are natural or artificial, plants, animals, human beings, but also liquid or solid particles suspended in air, such as clouds, or even liquid or gaseous masses.

The invention notably applies to the field of navigation for robots, drones, autonomous vehicles, etc., and more generally to that of perception.

With the proliferation of computation means that can be integrated into a robot, robotics applications have multiplied in recent years, from industrial production to home automation, space and submarine exploration to drone toys for the general public. The tasks carried out in robotics applications have progressively become more complicated, for robots this increasingly involves being able to move in unknown environments, which has made the development of perception means and techniques increasingly important, i.e. allowing the surrounding space to be discovered and understood. An important application that uses perception for robotics is navigation, which involves setting a robot a destination objective, and allowing it to reach said destination while ensuring that any unknown and potentially moving obstacles are avoided; the robot is then responsible for planning its trajectory itself. A typical example, which is the subject of intense research, is the autonomous car.

There are two main families of perception techniques: geometric methods, which aim to identify the geometry of the objects in the surrounding space, and those based on an occupancy grid, which aim to determine whether a certain location is occupied by an obstacle (more generally, by a physical body). The invention relates to techniques based on an occupancy grid.

The theoretical foundations of perception methods based on probabilistic occupancy grids are described in the article by A. Elfes entitled “Occupancy grids: a stochastic spatial representation for active robot perception” (Sixth Conference on Uncertainty in Al, 1990).

A probabilistic occupancy grid is made up of a regular, generally two-dimensional (but it also can be three-dimensional) arrangement of cells cᵢ each representing a small region of space and characterized by a probability of occupancy P(o(cᵢ)), where P(⋅) represents the probability of an event and o(cᵢ) represents the event “the cell cᵢ is occupied by a physical body”. The probabilities of occupancy are computed based on the results z of distance measurements, which requires knowledge of an “inverse model” of the distance sensor, P(o(cᵢ)|z), where P(a|b) is the probability of the event a conditional upon the completion of the event b. In general, several distance measurements, carried out by a single sensor or by several sensors of the same type or of different types, help to determine the probabilities of occupancy of the cells cᵢ by means of an operation known as “Bayesian fusion”, because it uses the Bayes theorem. Let z₁ and z₂ be two distance measurements; the probability of occupancy of the cell cᵢ is therefore equal to:

$$P ( {o}_{i} \vert {z}_{1} , {z}_{2} ) = \frac{[ 1 - P ( {o}_{i} ) ] P ( {o}_{i} \vert {z}_{1} ) P ( {o}_{i} \vert {z}_{2} )}{[ 1 - P ( {o}_{i} ) ] P ( {o}_{i} \vert {z}_{1} ) P ( {o}_{i} \vert {z}_{2} ) + P ( {o}_{i} ) P ( {v}_{i} \vert {z}_{1} ) P ( {v}_{i} \vert {z}_{2} )} \qquad ( 1 )$$

where “oᵢ” is a shortened notation for o(cᵢ), “vᵢ” is the event “the cell cᵢ is not occupied”, and P(oᵢ) is the a priori probability of occupancy, i.e. before any measurement, of said cell. Often P(oᵢ)=0.5 is assumed for all the cells of the grid, but this is not always the case: for example, document EP 3364213 describes a method in which the a priori probabilities of occupancy are selected as a function of a context.

A direct application of the method described by A. Elfes requires numerous floating point computations and therefore requires significant resources in terms of computation power, which are not readily compatible with the constraints specific to the on-board systems. Document WO 2017/050890 describes a method for perceiving physical bodies with an occupancy grid that can be implemented only by means of integer computations, and therefore is particularly well suited to real-time on-board applications.

Determining the inverse model of a distance sensor is generally a difficult problem. Often, for the sake of simplification, this is carried out within the context of “single target” approximation, in which the sensor is considered to detect at most only a single physical body at any time. This approximation is generally reasonable in the case of sensors with a narrow detection region (typically of a few degrees). Document EP 3594719 describes an approach that allows this approximation to be surpassed and the inverse model of a sensor to be computed with a wide detection angle.

In order to implement one of the aforementioned methods, a set of sensors needs to be available with detection regions that cover the whole environment in which the physical bodies must be perceived or, more commonly, one or more sensors need to be available with a fairly wide detection region, scanning the environment according to an acquisition sequence. The simplest solution is to carry out a uniform scan, for example by means of a sensor mounted on a rotary turret. However, this solution is not optimal because it involves having to reach a compromise between the spatio-temporal resolution of the detection and the resources used. More complex acquisition schemes allow this disadvantage to be partly overcome, by more finely or more frequently sampling regions of the space that are considered to be more “interesting” than others.

For example, document U.S. Ser. No. 10/598,788 describes a detection system using a Lidar with a controllable viewing angle, for example by means of a micromirror array. Additional laser shots are introduced within a pre-established list of shots so as to make the sampling more dense in certain regions of interest. The system also allows the power of the shots to be controlled so as to standardize the laser power sent into each region of the space, and optionally to protect certain targets vulnerable to the power of the laser.

Document WO 2019/216937 describes a detection system using a Lidar with a controllable viewing angle, for example by means of a micromirror array, with the system also comprising a camera integrated with the reception optics of the Lidar and having the same field of view without parallax. The camera allows a threat or anomaly to be detected and a motion planning system to be notified accordingly, which system then introduces additional shots into the pre-established list of shots, at very low latency, so as to very rapidly improve the perception of the regions identified as threats.

These approaches, which are not specific to detection using a probabilistic occupancy grid, allow the spatio-temporal resolution of the detection of physical bodies for given resources to be improved, or allow the resources requirement (energy, computation, etc.) to be reduced, but not optimally. The invention aims to provide an additional improvement, within the specific context of probabilistic occupancy grid methods.

### SUMMARY OF THE INVENTION

According to the invention, this aim is achieved by virtue of a dynamic adaptation of the width of the detection region of an orientable distance sensor. Furthermore, the sensor is controlled in such a way that a narrow detection region is used to finely sample “regions of interest” of the environment, while a wider detection region is used for coarser, but faster, sampling of other regions of the environment. The regions of interest are extracted from the constructed occupancy grid from older measurements. Optionally, the orientation of the detection region of the sensor is also adaptively adapted, for example in order to feedback more frequently with respect to the regions of interest or, more simply, in order to take into account variations in the width of the detection region of the sensor, so as to avoid any “holes” in the scan of the environment.

Thus, an aim of the invention is a method for perceiving physical bodies in an environment, comprising the following steps, iteratively implemented by a computer or a dedicated digital electronic circuit:
a) controlling a sensor in an acquisition sequence, with said sensor having a detection region that can be oriented in the environment in order to acquire a plurality of distance measurements of said physical bodies;
b) applying, to each of said distance measurements, an inverse model of the corresponding sensor on an occupancy grid providing a discretized spatial representation of an environment of said sensor, in order to determine a probability of occupancy of a set of cells of said occupancy grid by a physical body; and
c) constructing a consolidated occupancy grid, each cell of which has a probability of occupancy computed by Bayesian fusion of the probabilities of occupancy estimated during step b);
characterized in that the detection region of the sensor has a variable angular width and in that the method also comprises the following steps:
d) identifying, based on said occupancy grid, at least one region of interest of the environment; and
e) determining one of said acquisition sequences defining, for each distance measurement, at least the orientation and the angular width of the detection region of the sensor, with at least the angular widths being determined based on the one or more regions of interest identified during step d), with said acquisition sequence being used during step a) of a subsequent iteration of the method.

According to particular embodiments of such a method:
during step e), the orientations of the detection region of the sensor can also be determined based on the one or more regions of interest identified during step d);
step c) can also comprise constructing a movement grid based on a time evolution of the probabilities of occupancy of the cells of the occupancy grid, and
step d) can comprise identifying at least one region of interest of the environment also based on the movement grid;
the sensor can be adapted to also provide speed measurements of the physical bodies, with said speed measurements being used by the step d) of identifying at least one region of interest of the environment;
the acquisition sequence determined during step e) can be adapted to sample the one or more regions of interest or their contours with a higher spatial and/or temporal resolution than the rest of the environment;
each of said inverse sensor models can be a discrete model, associating each cell of the corresponding occupancy grid, and for each distance measurement, with a probability class selected within the same set of finite cardinality, with each of said probability classes being identified by an integer index, and wherein, during said step c), the probability of occupancy of each cell of the consolidated occupancy grid is determined by means of integer computations carried out on the indices of the probability classes determined during said step b);
the inverse model of the sensor can be stored in a memory in the form of a data structure representing a plurality of grids, called model grids, associated with respective possible distance measurements and respective possible angular widths of the detection region, with at least some cells of a model grid corresponding to a plurality of contiguous cells of the occupancy grid belonging to the same angular sector from among a plurality of angular sectors into which the detection region of the sensor is subdivided, and associating the same probability of occupancy with each of these cells;
step c) can comprise constructing the consolidated occupancy grid also based on distance measurements originating from one or more auxiliary sensors.

A further aim of the invention is a system for perceiving physical bodies comprising:
at least one input port for receiving a plurality of signals representing distance measurements of said physical bodies originating from one or more sensors;
a data processing module configured to receive said signals as input and to use them to construct a consolidated occupancy grid and to determine an acquisition sequence by applying a method as described above;
a first output port for a signal representing the occupancy grid or the one or more regions of interest; and
a second output port for a signal representing the acquisition sequence.

Such a system can also comprise one or more distance sensors adapted to receive said signal representing the acquisition sequence from said second output port and to provide said one or more input ports with signals representing a plurality of distance measurements of physical bodies.

The or at least one distance sensor can be of the radar, Lidar or sonar type and can comprise a beamforming system for controlling the orientation and the angular width of an electromagnetic or acoustic radiation beam defining the detection region.

### BRIEF DESCRIPTION OF THE DRAWINGS

Further features, details and advantages of the invention will become apparent upon reading the description, which is provided with reference to the appended drawings, which are provided by way of an example and which respectively represent:

FIG. 1, reproduced from document WO 2017/050890 with amendments, an illustration of the notion of an occupancy grid;

FIG. 2, also reproduced from document WO 2017/050890, an illustration of the notion of a “direct” model of a distance sensor;

FIG. 3, also reproduced from document WO 2017/050890, an illustration of the notion of an “inverse” model of a distance sensor;

FIG. 4, also reproduced from document WO 2017/050890, an illustration of the notion of spatial discretization of an inverse model on an occupancy grid;

FIG. 5, also reproduced from document WO 2017/050890, an illustration of two methods for quantizing an inverse model of a sensor on an occupancy grid;

FIG. 6 and FIG. 7, reproduced from document EP 3594719, illustrations of the concept of “sector decomposition” used to compute the inverse model of a wide detection angle sensor;

FIG. 8, a block diagram of a method and a system according to one embodiment of the invention; and

FIG. 9, an illustration of the dynamic adaptation of the detection width of a distance sensor.

### DETAILED DESCRIPTION

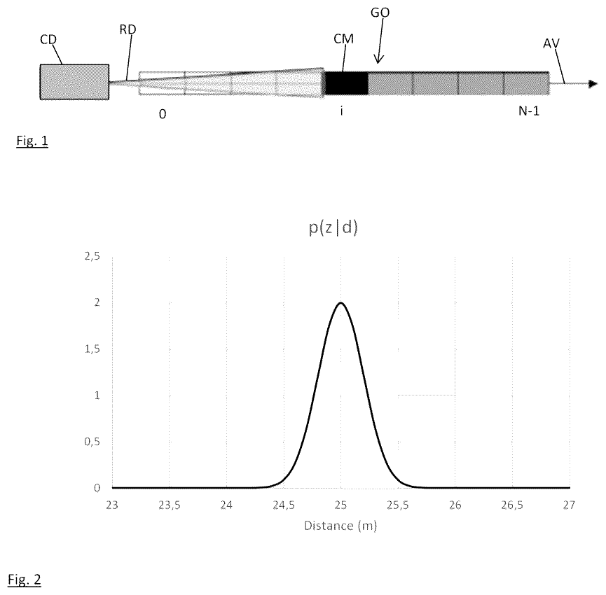

FIG. 1 schematically illustrates a configuration in which a distance sensor CD, with a narrow detection region RD, that can be modeled by a cone with a ˜5° half-angle aperture centered around a line of sight AV, is used to measure the distance relative to a material body CM located along the line of sight.

Let d be the actual distance between the physical body and the distance sensor CD, and z be the output of the sensor. Due to the inevitable measurement uncertainty, for a given value of d, the value of z will be a random variable characterized by the conditional probability density function p(z|d) that models the relationship between the actual position of a target and its estimation seen by the sensor (“direct model”).

FIG. 2 shows an example of a direct model of a distance sensor; a 50 m linear space is considered lengthwise and it is assumed that a target is located at d=25 m from the sensor. For a sensor with an error that can be modeled by a Gaussian function, the most probable response z will be close to 25 m, but other values will be possible, with a probability density defined by the curve. In the case of an ideal sensor, p(z|d)=δ(z−d), where δ is a Dirac delta function, and the measurement would always be equal to the true distance. The direct model of a sensor can be determined experimentally. Typically, it can be constructed based on data supplied by the manufacturer (in the Gaussian case, the value of the standard deviation is enough to characterize the model).

An occupancy grid GO is a partition of a continuous and delimited region of the space into a number N of parts, called cells and designated by an index iϵ[0, N−1]. The cell of index i is indicated using ci. In order to only illustrate the concepts of direct and inverse models, the present discussion will be limited to the case of a one-dimensional occupancy grid observed by a single distance sensor CD (or a plurality of co-located sensors), with the index i increasing as the sensors separate (with co therefore being the cell closest to the sensor and c_{N-1} being the cell furthest away), which corresponds to the configuration illustrated in FIG. 1.

A measurement z originating from a sensor allows the probability of occupancy P(oᵢ|z) of a cell ci to be determined. For a given measurement z, the set of probabilities P(oᵢ|z) ∀iϵ[0, N−1] forms the inverse model of the sensor on the grid. While the direct model of the sensor provides information concerning the response of the sensor as a function of the physical world, the inverse model expresses the impact of the measurement on the occupancy grid that is the model of the physical world that is adopted, which supports the name inverse model.

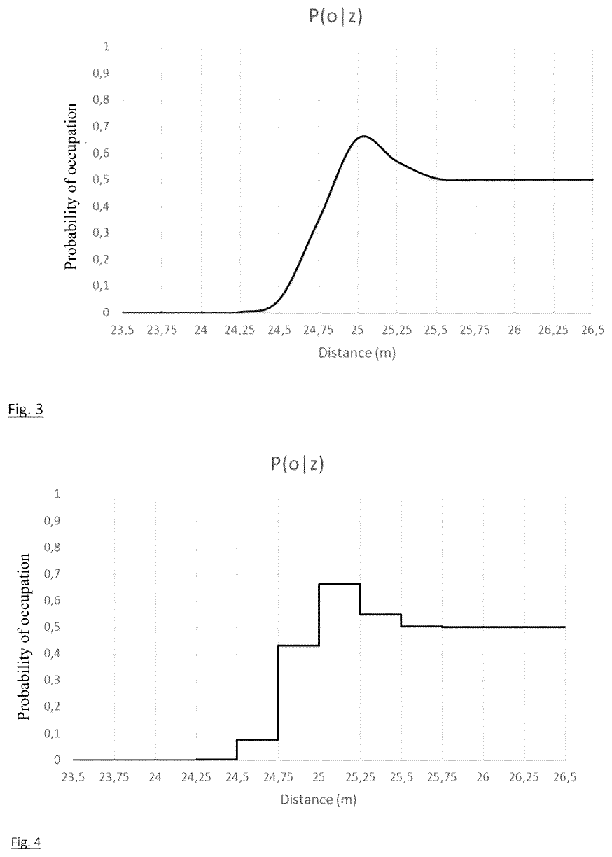

FIG. 3 shows a typical example of an inverse model of a distance sensor, in a case where z=25 m. It is possible to verify that the probability of occupancy is almost zero for the cells that are less than 24.25 m away from the sensor and reaches a peak for a distance of 25 m (corresponding to the measurement provided by the sensor). Beyond 25 m, the probability of occupancy decreases until it stabilizes at a value of 0.5, indicating a complete lack of knowledge of the state of occupancy of the cells, which, since they are located beyond the obstacle, are masked thereby and are therefore inaccessible to the sensor.

FIG. 3 represents the inverse model by means of a smoothed curve, but a more correct representation would be to display only the points corresponding to the limits of the cells of the grid: indeed, it is not possible to distinguish a “partially” occupied cell from another cell that would be “fully” occupied; in all cases the distance to the obstacle will be estimated as being the distance to the corresponding cell. This is the spatial error introduced by the grid.

A more accurate version of the inverse model of FIG. 3, taking into account this spatial discretization induced by the grid, is presented in FIG. 4.

The inverse model of FIG. 4 is spatially discretized, but the probability of occupancy of each cell can assume any real value within the interval [0; 1]. In practice, in a digital implementation, the probability values also must be quantized, according to a uniform or non-uniform quantization scheme. As explained in detail in document WO 2017/050890, some specific non-uniform quantization schemes allow drastic simplification of the computations required for “fusing” together, i.e. combining, the information provided by several distance measurements originating from the same sensor or from different sensors.

The quantization of the probabilities of occupancy involves representing the interval [0; 1] in a discretized manner, by means of “classes of probabilities” identified by integer indices. More specifically, the term “system of probability classes” S={pₙ, nϵZ} refers to a countable subset of [0; 1], for which the elements pₙ can therefore be characterized by a relative integer index “n”. If “F” refers to the fusion function of the data expressed by the above equation (1), then in the case that P(oᵢ)=0.5, the following can be expressed:

$$F ( {p}_{1} , {p}_{2} ) = \frac{{p}_{1} {p}_{2}}{{p}_{1} {p}_{2} + ( 1 - {p}_{1} ) ( 1 - {p}_{2} )} . \qquad ( 2 )$$

The generation in the case where P(oᵢ) is not necessarily equal to 0.5 does not pose a problem in principle and is studied in detail in document EP 3364213.

A particularly interesting case is that of a system of classes that is such that the result of the fusion of two classes of probabilities of the system also belongs to the system; formally: ∀pᵢ, pⱼϵS, F(p₁, p₂)ϵS. This is then referred to as an “error-free” system of classes, because the fusion does not introduce any errors or approximations. It is therefore possible to identify the probability values with the indices of the corresponding classes, and the result of a fusion is also identified by an index. The problem of Bayesian fusion then amounts to determining an appropriate function F_{d}, which, with two integer indices, associates another integer index. Formally:

$$∀ ( k , l ) ∈ {ℤ}^{2} , ∃ i ∈ ℤ : F ( {p}_{k} , {p}_{l} ) = {p}_{i} \qquad ( 3 )$$

and then F_{d}(k,l)=i.

The computation of F_{d}(k, l) only requires knowledge of the indices k and l and of the integer index arithmetic, no floating-point computation is required for computing the fusion of the information pₖ and pₗ. Furthermore, if the system of classes is considered, the index obtained using F_{d}(k, l) denotes a probability value that is strictly identical to that obtained, using floating-point numbers, by applying the equation (1). The method thus allows fusion of probability classes that are error-free with respect to a floating computation.

A first example of an error-free system of classes can be defined by recurrence.

Let p be a probability of occupancy strictly ranging between 0.5 and 1: 0.5<p<1. The series pₙ is then defined by recurrence as follows:
p₀=0.5;
p₁=p;
p₂=F(p,p);
p₃=F(p₂,p);
. . .
pₙ₊₁=F(pₙ,p).

The definition of pₙ is then extended to the negative integer values of n as follows:
p₀=0.5;
p₋₁=1−p;
p₋₂=F(p₋₁, p₋₁);
p₋₃=F(p₋₂, p₋₁);
. . .
pₙ₋₁=F(pₙ, p₋₁).

In the definitions of the classes pᵢ, the function F is defined by the equation (2).

The following two systems of classes are then defined, with a parameter pϵ]0.5, 1[:

$${G}_{p}^{+} = \{ ( {p}_{n} ) , n \geq 0 \}$$

$${G}_{p}^{-} = \{ ( {p}_{n} ) , n \leq 0 \}$$

By constructions, the systems of classes Gₚ⁻ and Gₚ⁺ are error-free. Furthermore, Gₚ=Gₚ⁻∩Gₚ⁺ defines a new system of classes, which can be used directly to carry out a Bayesian fusion and which can be shown to be error-free over its entire definition set.

Another possible discretization scheme for carrying out Bayesian fusion with only integer computations involves using the system of classes Sₖ=Sₖ⁺∩Sₖ⁻, where:

$${S}_{k}^{-} = \{ \frac{1}{2 - k \cdot n} , n \leq 0 \}$$

$${S}_{k}^{+} = \{ \frac{k \cdot n + 1}{k \cdot n + 2} , n \geq 0 \}$$

where k is a positive integer (kϵ [symbol] *). The disadvantage of this approach is that while Sₖ⁺ and Sₖ⁻ are effectively “error-free”, this is not the case for Sₖ.

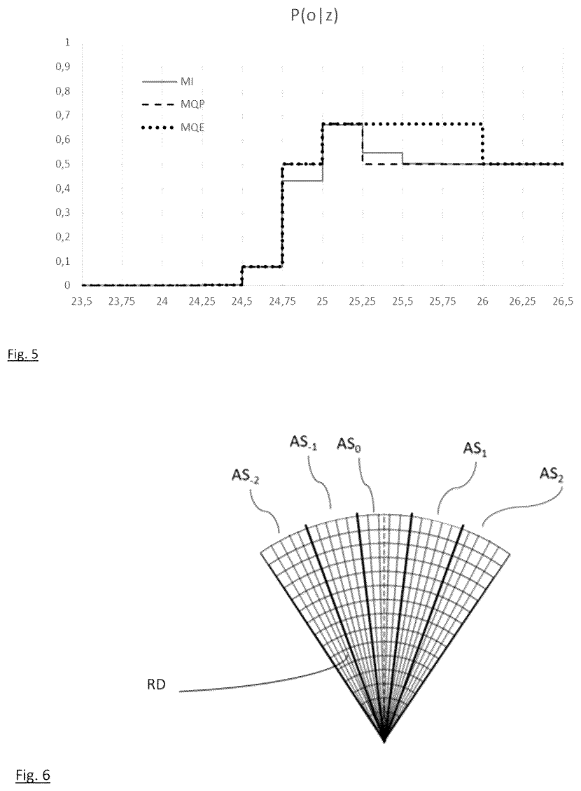

In order to quantify an inverse model that is already spatially discretized, it is possible to replace the values of the inverse model, represented by the curve MI in FIG. 5, with the elements of the discrete system of closest probability classes S, so as to minimize the quantization error. The result, in the case where the system of probability classes is S₁ (Sₖ with k=1), is represented by the curve MQP in FIG. 5. It can be seen that this approach can result in underestimating the probability of occupancy of a cell, which may not be acceptable in an obstacle detection application. An alternative involves approximating the values of the theoretical inverse model by the smallest majorant of the system of classes S (curve MQE in FIG. 5, still in the case of the system S₁). Thus, the probability of occupancy is never underestimated, which can be an advantage for obstacle detection. In other applications, such as counting people, this type of approximation can, however, result in the generation of false positives.

Until now only the case of a distance sensor with a narrow detection region has been considered, for which the probability of several physical bodies being simultaneously located in the detection region, at the same distance from the sensor, is negligible. In the case of a sensor with a detection region that is wider than a few degrees, this hypothesis generally is no longer fulfilled. Taking into account the possibility of having several physical bodies at the same distance from the sensor (with a tolerance lower than the spatial resolution of the occupancy grid) makes determining the inverse model more complicated. Indeed, it is possible to demonstrate that this determination requires computation of a sum of terms each corresponding to a possible configuration of the occupancy grid; in the case of a two-dimensional occupancy grid (unlike the one-dimensional case of FIG. 1), this number quickly becomes very large.

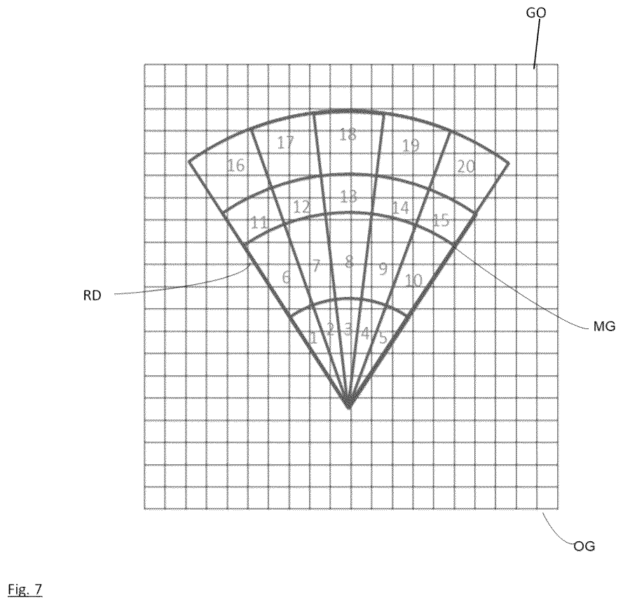

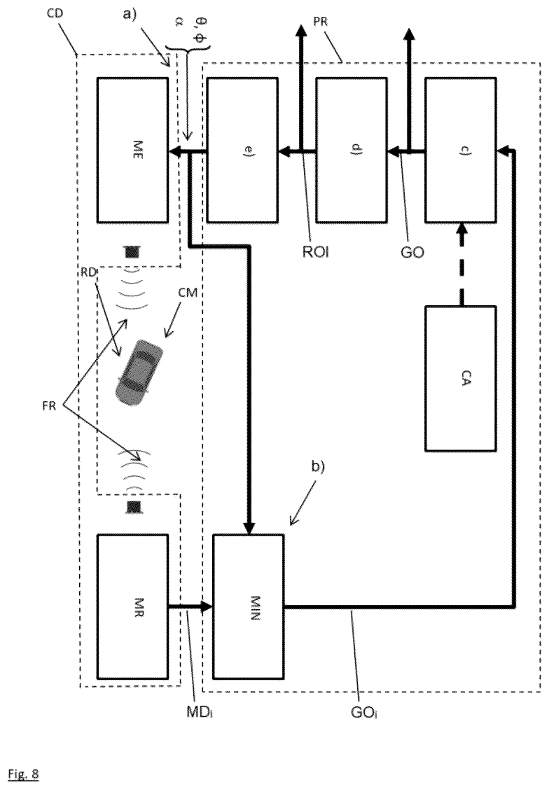

As explained in document EP 3594719, and illustrated in FIG. 6, it is advantageous for a “wide” detection region RD to be decomposed into a plurality of angular sectors AS₋₂, AS₋₁, AS₀, AS₁, AS₂, preferably with the same angular width and an odd number. As illustrated in FIG. 7, a “model grid” MG with polar geometry is defined on the detection region; this grid corresponds to the angular decomposition of FIG. 7, to which a relatively coarse radial decomposition is added with respect to the spatial resolution of the occupancy grid GO. Furthermore, in general, several cells of the occupancy grid correspond to the same cell of the model grid.

The inverse model of the sensor is made up of a plurality of model grids of the type shown in FIG. 7, associated with respective distance measurements. A conditional probability of occupancy P(o|z) is associated with each cell of each model grid. These probabilities are computed by considering all the configurations of the occupancy grid to be equivalent that comprise at least one occupied cell belonging to the same cell of the model grid.

In its own right, an occupancy grid contains only one item of position information relating to one or more physical bodies at a given instant. However, by comparing occupancy grids at different instants it is also possible to estimate the movements of said physical bodies, which can be represented by a “movement grid”, or “dynamic grid”, for which each cell occupied by a physical body contains information concerning the speed of said physical body. Speed sensors also can be used to construct such a movement grid, or to assist in its construction.

As mentioned above, the invention improves these environmental perception techniques, which involve dynamically adapting the width of the detection region of the sensor, while varying the orientation of its line of sight, so as to carry out non-uniform sampling of the environment. The distance measurements acquired by the sensor are used to construct a model of the environment based on an occupancy grid; in turn, this model is used to schedule the subsequent measurements, in particular by identifying regions that must be sampled more or less finely.

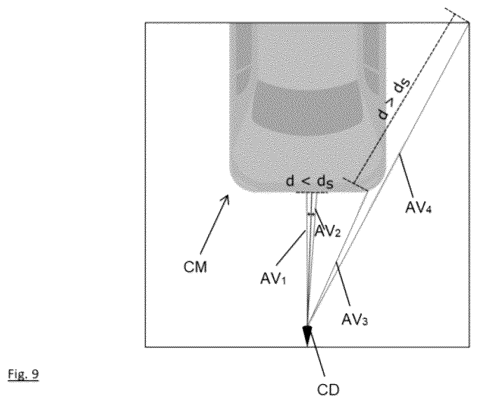

An embodiment of the invention will now be described in detail with reference to FIG. 8.

A system according to the invention basically comprises a distance sensor CD and a processor PR. The term “processor” will be used herein to define a data processing system, comprising, for example, one or more microprocessors and/or digital electronic circuits that are appropriately programmed or configured and are interconnected to cooperate with one another and with the sensor. The processor PR can be, for example, integrated into the sensor, separate from the sensor or can comprise components integrated into the sensor that are intended to control the sensor and/or to carry out initial operations on the measurement data and can comprise one or more external components that are intended to carry out higher level operations. The term “computer” will be used to designate any programmable processor, and does not necessarily designate a generic computer.

The distance sensor CD comprises an emission module ME and a reception module MR. The emission module ME generates a radiation beam FR, the polar angle θ (or colatitude, or zenith angle) and/or the azimuth angle (or longitude) φ of which, as well as the aperture angle α, can be controlled by the processor PR. The radiation beam thus defines a detection region RD that can be oriented and has a modifiable width. The reception module MR detects a portion of the radiation scattered by a physical body CM located in the detection region RD. In FIG. 8, the emission and reception modules are located on either side of the physical body, in reality, in most embodiments, they will be co-located.

For example, the sensor CD can be a time-of-flight sensor, notably of the Lidar type. Even more specifically, it can be a Frequency-Modulated Continuous-Wave (FMCW) Lidar. In this case, the emission module can comprise a laser emitter and the associated beam generation optic, and the module for receiving a photodetector with the optical system and the associated electronic circuits. In order to allow “agile” reconfiguration of the beam, and therefore of the detection region, the beam generation optic of the emission module will preferably be able to include an Optical Phased Array (OPA), which allows the orientation and the width of the beam to be controlled in an electronic/optical manner, without moving parts, or without moving macroscopic parts in the case of an OPA of the micro-opto-electro-mechanical type. Optionally, the energy of the beam also can be controlled. As a variant, the sensor can be of the radar or sonar type. The use of a rotary turret for orienting the detection region is possible but not optimal since it lacks agility (the azimuth angle changes continuously and therefore cannot be freely controlled, in addition, in order to avoid “holes” in the scan, the speed of rotation would need to be dynamically adapted to the width of the beam, which is very difficult).

In a step a) of the method of FIG. 8, the sensor CD is controlled by the processor PR to acquire distance measurements. When a new distance measurement MDᵢ (with “i” being an integer index allowing a specific measurement to be identified in a series of N>1 distance measurements) is acquired by the sensor, the datum of the measurement and the configuration information of the beam (θ, φ, α) are processed by the processor PR in order to construct an occupancy grid GOᵢ (step b)). To this end, the processor uses an inverse model MIN of the sensor taking into account the angular width of the beam FR, for example of the type described in EP 3594719. The occupancy grid GOᵢ is then fused (Bayesian fusion) with a consolidated occupancy grid GO, constructed based on the previously acquired measurements and modeling the environment, for example by using the algorithm described in detail in documents WO 2017/050890 and EP 3364213, which has been reviewed above (step c)). In addition, the measurement data can be used to construct one or more dynamic grids.

Data originating from one or more auxiliary sensors CA can also cooperate with the structure of the consolidated occupancy grid, also by Bayesian fusion. The auxiliary sensors can be distance or speed sensors, such as Lidars, sonars, radars, stereo cameras, etc.

Advantageously, the Bayesian fusion of the measurement data is supplemented by a “forgetting factor”: before fusion with the occupancy grid GOᵢ, the consolidated occupancy grid GO, derived from the measurements MDⱼ j=0 . . . i−1, undergoes processing that approximates the probability of occupancy of each cell by the value 0.5, which corresponds to a perfectly unknown state. Thus, greater prominence is given to the most recent information. This is particularly important in the case where the physical bodies and/or the sensor are movable.

Then, during a step d), the processor analyzes the consolidated occupancy grid GO and, where appropriate, the one or more dynamic grids in order to identify one or more “regions of interest” ROI of the environment. A region of interest is a region of the environment that is of particular interest and therefore must be sampled more finely and/or more frequently than other regions, or, conversely, a region that is predefined as “empty” or “of lesser interest” can be sampled more coarsely and/or less frequently. The criteria for identifying a zone of interest can be varied and can depend on the specific considered application. For example, identifying regions of interest can be based on measured distance gradients, speed gradients of the detected physical bodies (if a dynamic grid is used in addition to the occupancy grids), the spatial density of said bodies, a temporal variation of the probabilities of occupancy, etc. It is also possible to take into account the time that has elapsed from the last time a zone of the environment was visited and/or considered to be of “interest” to the regions in which the probability of occupancy of the cells is close to 0.5 (which means that their state is unknown). In some embodiments, it is also possible to apply artificial intelligence methods to identify objects, for example vehicles, and to consider the regions occupied by these objects to be regions of interest.

The regions of interest ROI can be represented in various ways. A first possibility (“pixel format”) involves creating a grid with the same format as the occupancy grid, but whose cell values represent a level of interest. For example, it is possible to contemplate that the cells corresponding to a region of interest assume a value of “1” and that the others assume a value of “0”. It is also possible to use several different levels of interest, for example: “0” for the cells that do not belong to an ROI, “1” for the cells of a first category ROI, “2” for the cells of a second category ROI, and so on. A second possibility (“object format”) involves defining an ROI by a position (for example, that of its center), its shape and orientation, its size, and optionally its level of interest.

In a step e), the processor PR determines, based on the ROI thus identified, a measurement acquisition sequence that is in the form of a list of commands defining, for each measurement, the polar angle (colatitude) θ and/or the azimuth angle (longitude) φ, as well as the aperture angle α of the beam, and optionally its energy. Various criteria can be used to construct the acquisition sequence. In particular, the aperture angle α is different for the regions of interest and for the rest of the environment; typically, it is smaller in the regions of interest to ensure finer spatial sampling. If there are several categories of regions of interest, there may be respective values of the aperture angle α; typically, α will be smaller the higher the level of interest of the ROI. Furthermore, the frequency of the measurements can be different for the regions of interest and for the rest of the environment; typically, the ROIs will be measured more frequently than the rest of the environment in order to ensure finer time sampling. For example, it is possible to contemplate uniform time sampling of the environment (any region is measured every “T” seconds), to which additional measurements are added that are solely aimed at the regions of interest. If there are several categories of regions of interest, the ROIs with a higher level of interest could be measured more frequently than those with a lower level of interest.

The commands forming the acquisition sequence are used by the processor to control the sensor CD, and notably its emission module (step a), again, with the method being iterative). They are also used to select the appropriate inverse sensor model, which will be used to construct the occupancy grid GOᵢ corresponding to each measurement. In this respect, it should be noted that the sensor modeling can be of the continuous or discrete type. In continuous modeling, the value of the beam aperture angle can be selected arbitrarily and is modeled as such. This involves spontaneously recomputing the model for each new aperture angle. This option requires more computation resources but is more precise. In discrete modeling, a predefined number of inverse models corresponding to given values of the aperture angle is computed beforehand and stored in a memory of the processor. This option is faster in terms of computation time, but is either less precise, or allows fewer beam aperture angles.

Various data produced at different times of the method can be output from the system. It can be, for example, the consolidated occupancy grid GO, “point cloud” type modeling of the environment constructed based on GO, a list of ROIs, raw measurement data originating from the sensors, etc.

In a particular embodiment of the invention, the distance sensor CD is an FMCW Lidar, the angular aperture and the beam direction of which are controllable by virtue of an OPA by adjusting the phase shift of each of the channels thereof. More specifically, the OPA varies the azimuth angle φ over discrete steps while taking into account variations in the width of the beam from one “shot” to the next in order to scan the environment without any holes or overlapping of the detection regions corresponding to successive “shots”. According to a first embodiment, the polar angle (or colatitude) θ is kept constant, which results in a two-dimensional scan. As a variant, the OPA can be used to vary the polar angle θ in order to carry out a three-dimensional scan. It is also possible to vary θ by mounting the OPA on a support of the vibrating beam type, or even to use several stacked OPA to carry out two-dimensional scans in parallel planes at different heights.

For the sake of simplicity, the case where the OPA can be controlled so as to produce two different angular apertures of the beam of the Lidar will be considered: α₀ and 2α₀, but a generalization to a larger number of angular apertures is not problematic.

The sensor acquires a series of distance measurements corresponding to various viewing directions (φ, θ) so as to scan said layer of the environment. If the adaptive approach of the invention is not implemented, the system user can choose between two alternatives. Either they use the smallest angular aperture to maximize the resolution, but this results in an acquisition number equal to 2π/α₀ (assumed to be an integer) for each round. This can require limiting the rate of the shots to avoid exceeding the computation power of the processor, thus limiting the time resolution, or using a more powerful and thus more expensive and more energy-consuming processor. Or they use the largest angular aperture, but at the expense of a reduction in spatial resolution, which can result in the loss of important details. A compromise is therefore made between spatial resolution and time resolution.

The invention allows the highest spatial resolution to be used (angular aperture α₀) only where it is really necessary, i.e. in accordance with regions of interest identified by means of a suitable criterion, and the lowest spatial resolution to be used (angular aperture 2α₀) so as to reduce the number of acquisitions and therefore increase their rate.

According to one embodiment of the invention, a criterion for identifying regions of interest is based on the deviations between two successive distance measurements, corresponding to adjacent regions of the environment. If this deviation, denoted “d”, exceeds a threshold “dₛ”, the sensor can be considered to be in the process of exploring the contour of an object, or an object whose surface forms a significant angle with the line of sight. In both cases, it is worthwhile using the angular aperture α₀ in such a way as to precisely observe the contours. In the other cases, the loss of precision is considered to be acceptable if two consecutive “shots” with an angular aperture α₀ are replaced by a single shot with an angular aperture 2α₀, for which the line of sight coincides with the bisecting line of the directions of the two replaced shots.

This is illustrated in FIG. 9, which shows a first pair of shots, represented by the lines of sight AV₁, AV₂ of the corresponding Lidar beams, for measuring the distance from the rear face of a car (physical body CM) to the sensor CD, and a second pair of shots, also represented by the lines of sight AV₃, AV₄ of the corresponding Lidar beams, sampling the edge of said rear face, i.e. the transition between the rear edge and the side of the vehicle. The difference d between the two distance measurements carried out in the directions AV₁ and AV₂ is low, much less than the threshold dₛ. Consequently, during successive acquisitions, the corresponding region of the environment will be sampled in a relatively coarse manner, by means of Lidar beams with an angular aperture 2α₀. By contrast, the difference d between the two distance measurements carried out in the directions AV₃ and AV₄ is high, greater than the threshold dₛ. Consequently, during successive acquisitions, the corresponding region of the environment will be considered to be a region of interest and will be finely sampled by means of Lidar beams with an angular aperture α₀.

In this example, the choice of regions of interest governing the targeting policy is solely based on the deviations in distance between successive shots but, as explained above, the module for selecting regions of interest can assume much more complex forms, being based, for example, on semantic data of the scene, or by prioritizing the regions of the space where knowledge of the environment is the most uncertain by virtue of the occupancy grid approach.

In this example, the OPA of the sensor was used to vary the azimuth angle φ in a monotone manner (although not uniform, with the pitch variation of φ depending on the width of the beam in accordance with each shot), so that all the points of the environment are sampled at the same rate. It is also possible to use the OPA to vary the orientation of the detection region in an “agile” manner, by sampling the various regions of the space at the most opportune time.

As mentioned above, mechanical scanning by means of a rotary turret can be contemplated but has notable disadvantages with respect to the use of an OPA. A hybrid embodiment, combining mechanical orientation and using the OPA is also possible in order to obtain a 360° field of view, which is not possible with an OPA alone.

1. A method for perceiving physical bodies (CM) in an environment, comprising the following steps, iteratively implemented by a computer or a dedicated digital electronic circuit (PR):
a) controlling a sensor (CD) in an acquisition sequence, with said sensor having a detection region (RD) that can be oriented in the environment in order to acquire a plurality of distance measurements (MDᵢ) of said physical bodies;
b) applying, to each of said distance measurements, an inverse model (MIN) of the corresponding sensor on an occupancy grid (GOᵢ) providing a discretized spatial representation of an environment of said sensor, in order to determine a probability of occupancy of a set of cells of said occupancy grid by a physical body; and
c) constructing a consolidated occupancy grid (GO), each cell of which has a probability of occupancy computed by Bayesian fusion of the probabilities of occupancy estimated during step b);
wherein the detection region of the sensor has a variable angular width (α) and in that the method also comprises the following steps:
d) identifying, based on said occupancy grid, at least one region of interest (ROI) of the environment; and
e) determining one of said acquisition sequences defining, for each distance measurement, at least the orientation (θ, φ) and the angular width (α) of the detection region of the sensor, with at least the angular widths being determined based on the one or more regions of interest identified during step d), with said acquisition sequence being used during step a) of a subsequent iteration of the method.

2. The method as claimed in claim 1, wherein, during step e), the orientations of the detection region (RD) of the sensor (CD) are also determined based on the one or more regions of interest (ROI) identified during step d).

3. The method as claimed in claim 1, wherein step c) also comprises constructing a movement grid based on a time evolution of the probabilities of occupancy of the cells of the occupancy grid, and step d) comprises identifying at least one region of interest (ROI) of the environment also based on the movement grid.

4. The method as claimed in claim 1, wherein the sensor is adapted to also provide speed measurements of the physical bodies, with said speed measurements being used by the step d) of identifying at least one region of interest (ROI) of the environment.

5. The method as claimed in claim 1, wherein the acquisition sequence determined during step e) is adapted to sample the one or more regions of interest (ROI) or their contours, either with a higher spatial and/or temporal resolution than the rest of the environment, or with a lower spatial and/or temporal resolution than the rest of the environment.

6. The method as claimed in claim 1, wherein each of said inverse sensor models (MIN) is a discrete model (MQP, MQE), associating each cell of the corresponding occupancy grid (GOᵢ), and for each distance measurement (MDᵢ), with a probability class selected within the same set of finite cardinality, with each of said probability classes being identified by an integer index, and wherein, during said step c), the probability of occupancy of each cell of the consolidated occupancy grid (GO) is determined by means of integer computations carried out on the indices of the probability classes determined during said step b).

7. The method as claimed in claim 1, wherein the inverse model of the sensor (MIN) is stored in a memory in the form of a data structure representing a plurality of grids, called model grids, associated with respective possible distance measurements and respective possible angular widths of the detection region, with at least some cells of a model grid corresponding to a plurality of contiguous cells of the occupancy grid belonging to the same angular sector from among a plurality of angular sectors (AS₁-AS₄) into which the detection region (RD) of the sensor (CD) is subdivided, and associating the same probability of occupancy with each of these cells.

8. The method as claimed in claim 1, wherein step c) comprises constructing the consolidated occupancy grid also based on distance measurements originating from one or more auxiliary sensors (CA).

9. A system for perceiving physical bodies (CM) comprising:
at least one input port for receiving a plurality of signals representing distance measurements (MDᵢ) of said physical bodies originating from one or more sensors;
a data processing module (PR) configured to receive said signals as input and to use them to construct a consolidated occupancy grid (GO) and to determine an acquisition sequence by applying a method as claimed in claim 1;
a first output port for a signal representing the occupancy grid (GO) or the one or more regions of interest (ROI); and
a second output port for a signal representing the acquisition sequence (α, θ, φ).

10. The system as claimed in claim 9, further comprising one or more distance sensors (CD) adapted to receive said signal representing the acquisition sequence from said second output port and to provide said one or more input ports with signals representing a plurality of distance measurements of physical bodies.

11. The system as claimed in claim 10, wherein the or at least one distance sensor is of the radar, Lidar, or sonar type and comprises a beamforming system for controlling the orientation and the angular width of an electromagnetic or acoustic radiation beam defining the detection region.
